(19) United States
(12) Patent Application Publication
(10) Pub. No.: US 2024/0094677 A1
(43) Pub. Date: Mar. 21, 2024

(54) SYSTEM AND METHOD FOR REDUCING SCATTER AND CROSSTALK IN SELF-DEVELOPING HOLOGRAPHIC MEDIA

(71) Applicant: Vuzix Corporation, West Henrietta, NY (US)

(72) Inventor: Stephen P. McGrew, Spokane, WA (US)

(21) Appl. No.: 18/283,686

(22) PCT Filed: Mar. 22, 2022
(86) PCT No.: PCT/US2022/021438

§ 371 Date: Sep. 22, 2023

Related U.S. Application Data
(60) Provisional application No. 63/164,251, filed on Mar. 22, 2021.

(51) Int. Cl. G03H 1/18

(52) U.S. Cl. CPC G03H 1/182; G03H 2001/0264; G03H 2240/52; G03H 2260/12

(57) ABSTRACT

A method for decreasing scatter or crosstalk in holographic elements recorded in self-developing media, comprising exposing a photopolymer recording media to a holographic pattern at a first temperature of said photopolymer recording media, wherein monomer diffusion is substantially reduced at said first temperature, and warming said photopolymer recording media to a second temperature wherein monomer diffusion is enabled.

### TECHNICAL FIELD

The present disclosure relates generally to self-developing holographic recording media and more particularly to a method of reducing scatter and crosstalk in self-developing holographic media.

### BACKGROUND

Holograms are typically recorded in photopolymer holographic recording media by projecting two collimated beams, an object beam and a reference beam, so that the beams overlap at a relative angle to each other on the photopolymer holographic recording media. The photopolymer holographic recording media is exposed to an interference pattern, also referred to as a holographic pattern, made by the object beam and reference beam, wherein both phase and amplitude information are recorded as a hologram. The photopolymer is typically coated or mounted on a glass plate, thin film or other suitable substrate.

In the photopolymer holographic recording media, light exposure causes monomers to convert to dimers or larger molecular structures. The conversion of monomers to dimers or larger molecular structures removes the monomer locally (i.e., via diffusion-induced monomer depletion), which results in diffusion of the monomer to the exposed region. Diffusion of the monomer to the exposed region increases the local density of the holographic recording medium in the exposed regions and reduces the local density of the holographic recording medium in the unexposed regions.

Any light scatter that occurs due to surface imperfections in the recording setup, such as surface imperfections on the photopolymer holographic recording medium or inconsistencies within the photopolymer holographic recording medium (referred to collectively as “inherent scatter”), is recorded as a hologram along with the intended hologram recording. Both the object beam and the reference beam in such a recording contain scatter. Because the hologram self-develops during the recording exposure, both the object beam and the reference beam reconstruct the recorded scatter as well as being inherently scattered, therefore the total amount of scatter is amplified by the self-development dynamics.

It some embodiments, more than one hologram element is recorded on the photopolymer holographic recording medium. Typically, one of two processes is used to record multiple hologram elements: the parallel or coherent process, and the step and repeat process. In the parallel, or coherent process, multiple hologram elements are fabricated simultaneously, for example by separating the object beam into a matrix of component beams, and directing a single image onto the photopolymer holographic recording medium to form the multiple hologram elements in the medium. In the step and repeat process, the hologram elements are separately fabricated. In one embodiment, for example, the object beam is directed through an image and then onto the photopolymer holographic recording medium. This step is repeated to fabricate multiple holographic elements, with the signal beam directed to the same photopolymer holographic recording medium for each step. If two independent hologram elements are recorded in the same volume of a photopolymer holographic recording medium, and if the angle between either the reference beam or the object beam of one hologram is close to the angle of the reference beam or the object beam of the other hologram, both inherent and amplified scatter can cause crosstalk such that both holograms are reconstructed by a single illumination beam.

Scatter and crosstalk are recurrent problems in the recording and reconstruction of holograms in self-developing holographic media, such as photopolymers, where the recording mechanism involves diffusion of molecular species within the medium. The present disclosure provides a method for greatly reducing those problems. The present disclosure provides, inter alia, for slowing the self-development process in photopolymer holographic recording media and thereby reducing amplification of scatter; and, consequently, reducing the amount of crosstalk between angularly multiplexed holograms.

### SUMMARY

A method for decreasing scatter or crosstalk in holographic elements recorded in self-developing media having a development rate that is temperature dependent, including recording a holographic pattern in the medium at a first temperature at which temperature the development rate is relatively slow, and after recording, changing the temperature of the medium to a second temperature at which the development rate is relatively fast.

According to an aspect of the present disclosure, there is provided a method for decreasing scatter or crosstalk in holographic elements recorded in self-developing media, comprising exposing a photopolymer recording media to a holographic pattern at a first temperature of the photopolymer recording media, wherein monomer diffusion is substantially reduced at the first temperature, and warming the photopolymer recording media to a second temperature wherein monomer diffusion is enabled.

In an embodiment, a rate of holographic development is increased at the second temperature relative to the first temperature. In yet a further embodiment, the method comprises maintaining the photopolymer recording media at the first temperature during exposure to the holographic pattern, wherein the first temperature is at or below twenty-degrees Celsius. In a further embodiment, the method includes maintaining the photopolymer recording media at the first temperature during exposure to the holographic pattern, wherein the first temperature is at or below twenty-degrees Celsius.

In yet another embodiment, the method comprises maintaining the photopolymer recording media at the first temperature during exposure to a first holographic pattern; maintaining the photopolymer recording media at the first temperature during exposure to a second holographic pattern; and maintaining the photopolymer recording media at the first temperature between exposure to the first and second holographic patterns.

The method further comprising, in an embodiment, chilling a room in which the photopolymer recording media is exposed to the holographic pattern to a temperature at or below the first temperature.

In another embodiment the method further comprises exposing the photopolymer recording media to incoherent light at the second temperature. In an alternate embodiment, the method further comprises exposing the photopolymer recording media to two or more mutually incoherent light beams at the second temperature.

In an embodiment, the method further comprises locating the photopolymer recording media in a temperature controlled enclosure, wherein the enclosure is operable to enable exposure of the photopolymer recording media to the holographic pattern. The method further comprises, in another embodiment, that the temperature controlled enclosure is operable to enable exposure of the photopolymer media to another holographic pattern. The method, in an embodiment, further comprises locating the photopolymer recording media in a humidity controlled enclosure, wherein the enclosure is operable to enable exposure of the photopolymer recording media to the holographic pattern. The method further comprises, in another embodiment, that the humidity controlled enclosure is operable to enable exposure of the photopolymer media to another holographic pattern. The method further comprises, in an embodiment, chilling a substrate on which the photopolymer recording media is located to a temperature at or below the first temperature. The first temperature, in one embodiment, is substantially at or below 2.5-degrees Celsius. In one embodiment, the enclosure encloses all optical components of a system used to record a holographic pattern onto the photopolymer medium.

In another embodiment, the method includes the step of exposing the photopolymer recording media to a holographic pattern which includes the steps of generating a coherent light beam, expanding the coherent light beam into an expanded beam with a beam expander, splitting the expanded beam into a first beam and a second beam with a beam splitter, and intersecting the first beam and second beam within the photopolymer recording media to form the holographic element, wherein the temperature controlled enclosure includes the beam expander, the beam splitter, and the first and second beams.

In another embodiment, the present disclosure includes the step of exposing the photopolymer recording media to a holographic pattern which includes the step of intersecting a first beam and a second beam within the photopolymer recording media to form the holographic element, wherein the temperature controlled enclosure includes enclosing surfaces having optical holes for optically passing the first beam and second beam through the enclosing surfaces to chill the photopolymer recording media.

In another embodiment, the method further includes the step of exposing the photopolymer recording media to a holographic pattern which includes the steps of generating a coherent light beam, expanding the coherent light beam into an expanded beam with a beam expander, splitting the expanded beam into a first beam and a second beam with a beam splitter, and intersecting the first beam and second beam within the photopolymer recording media to form the holographic element, wherein the humidity controlled enclosure includes the beam expander, the beam splitter, and the first and second beams.

In another embodiment, the present disclosure includes the step of exposing the photopolymer recording media to a holographic pattern which includes the step of intersecting a first beam and a second beam within the photopolymer recording media to form the holographic element, wherein the humidity controlled enclosure includes enclosing surfaces having optical holes for optically passing the first beam and second beam through the enclosing surfaces to chill the photopolymer recording media.

According to another aspect of the present disclosure, there is provided a holographic recording apparatus for decreasing scatter or crosstalk in holographic elements recorded in self-developing media, comprising a light source operable to generate a coherent light beam, a beam expander operable to expand the coherent light beam into an expanded beam, a beam splitter operable to form a first beam and a second beam from the expanded beam, the first beam and second beam intersects the photopolymer recording media, wherein interference of the first and second beams within the photopolymer recording media is operable to form Bragg planes, and a temperature controlled enclosure located about the photopolymer recording media, wherein the first and second beams are operable to intersect within the enclosure. The enclosure, in an embodiment, at least partially comprises a thermally insulative material. The enclosure also includes, in an embodiment, a heat pump operable to reduce a temperature within the enclosure. The enclosure can further comprise (i) one or more temperature sensors operable to determine a temperature of the photopolymer recording media; (ii) a humidity control system operable to control humidity within the enclosure; and/or (iii) one or more humidity sensors operable to determine a humidity within the enclosure.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 illustrates a conventional holographic recording system.

FIG. 2 illustrates a holographic recording system according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

The self-development process of a hologram captured in photopolymer holographic recording media depends on diffusion of a monomer species within the photopolymer holographic recording medium. By slowing diffusion of monomer species within the photopolymer holographic recording medium, self-development is slowed. As a result, amplification of scatter is reduced.

A direct way of slowing diffusion of monomer species during exposure is to maintain the photopolymer holographic recording medium at a reduced temperature. For example, the amount of amplified scatter is substantially reduced when the temperature of the photopolymer holographic recording medium is reduced from “room” temperature (approximately 20-degrees C.) to a lower temperature between 20-degrees C. and 0-degrees C. In one embodiment, the temperature of the photopolymer holographic recording medium is reduced to approximately 2.5-degrees C. In another embodiment, the temperature of the photopolymer holographic recording medium is reduced to a temperature within the temperature range between approximately 1.0-degree C. and 5.0-degrees C. In another embodiment, the photopolymer holographic recording medium is cooled to a temperature within the temperature range between approximately 0-degrees C. and 20-degrees C. In one embodiment, scatter is substantially inhibited such that scatter is almost negligible, even if there is almost zero.

In the field of photography, it has been common to chill photographic emulsions in order to increase their sensitivity by slowing decay of excited states of partially exposed silver halide crystals. According to the present disclosure, chilling actually decreases sensitivity of a photopolymer holographic recording medium. Chilling a photographic emulsion does not substantially affect scatter, whereas chilling a photopolymer holographic recording medium significantly reduces amplified scatter. It should be understood that the method disclosed herein can be used in other self-developing holographic recording media where the rate of development is temperature-dependent.

When diffusion of molecular species is sufficiently slowed in a photopolymer holographic recording medium to ensure that the majority of index of refraction modulation occurs after exposure is complete, the index of refraction modulation does not substantially affect the recording process and is not able to substantially amplify inherent scatter.

When two holograms are recorded in the same region of a photopolymer holographic recording medium, the amount of crosstalk, wherein projections at different depths contaminate each other, is a function of several factors that include the amount of recorded/amplified scatter. Therefore, crosstalk is reduced in photopolymer holograms when the recording is performed on a time scale that is short compared to the diffusion time. Chilling the photopolymer holographic recording medium slows the rate of diffusion of molecular species substantially. Diffusion time is, in this context, related to the distance between recorded bright and dark regions of the combined reference and object illumination beams, and the diffusion rate (which is monomer concentration dependent). In one embodiment, crosstalk is substantially inhibited by chilling the photopolymer holographic recording medium such that crosstalk is almost negligible, even if there is almost zero.

There are a number of techniques and apparatuses operable to maintain a photopolymer holographic recording medium at low temperatures. As a non-limiting example, it is possible to maintain the photopolymer holographic recording medium at a low temperature by: chilling the room in which the holographic recording is done, chilling the immediate environment of the photopolymer holographic recording medium, and/or chilling a substrate on which the photopolymer holographic recording medium is mounted. An important consideration in chilling the photopolymer holographic recording medium is the possibility of the condensation of moisture on optical surfaces due to the reduction of the temperature of the optical surfaces. Condensation can increase scatter. Condensation can be prevented by utilizing anti-fog coatings on the optical surfaces, or by maintaining a low-humidity environment in the vicinity of the chilled elements of the recording system including the environment of the photopolymer holographic recording medium itself.

The method disclosed herein is directly applicable to, but not limited to, making low-haze near-eye displays, when the displays employ photopolymer holographic optical elements. For example, a volume hologram can be transparent to ambient light but diffract light of a specific wavelength with high angular and spectral selectivity. Therefore, a near-eye display utilizing a photopolymer holographic optical element to form a volume hologram can be transparent to ambient light and provide a clear view of the environment, but at the same time provide a three-dimensional computer generated view or remotely recorded view superimposed on the environment. Similarly, the presently disclosed method provides for improving the signal-to-noise ratio in optical data recording systems that use photopolymer holographic recording media.

It is important to note that the disclosed method of chilling the photopolymer holographic recording medium to reduce monomer diffusion speed can be applied to other self-developing optical recording media that depend on monomer diffusion for their self-development process. Moreover, it is possible to design photopolymer media and other media in which monomer diffusion is very slow at room temperature, but dramatically faster at elevated temperatures. In such media, the important point is that the recording exposure is performed at a temperature that inhibits diffusion, and then the temperature of the photopolymer holographic recording medium is raised to allow diffusion and self-development.

Additionally, in some embodiments, the holographic recording media will be illuminated at a higher temperature after the initial pattern is recorded to amplify the image. In such an embodiment, after exposure to a series of interference patterns at the reduced temperature to form a virtual image, the photopolymer medium is exposed at a higher temperature to incoherent light both to amplify the virtual image and to fix the amplified image. In another embodiment, after exposure to a series of interference patterns at the reduced temperature to form a virtual image, the photopolymer medium is illuminated at a higher temperature to two or more mutually incoherent light beams at conical diffraction angles corresponding to the interference patterns, thereby reconstructing the virtual image to form an amplified version of the interference patterns in the photopolymer medium. Further exposure to incoherent light fixes the amplified image.

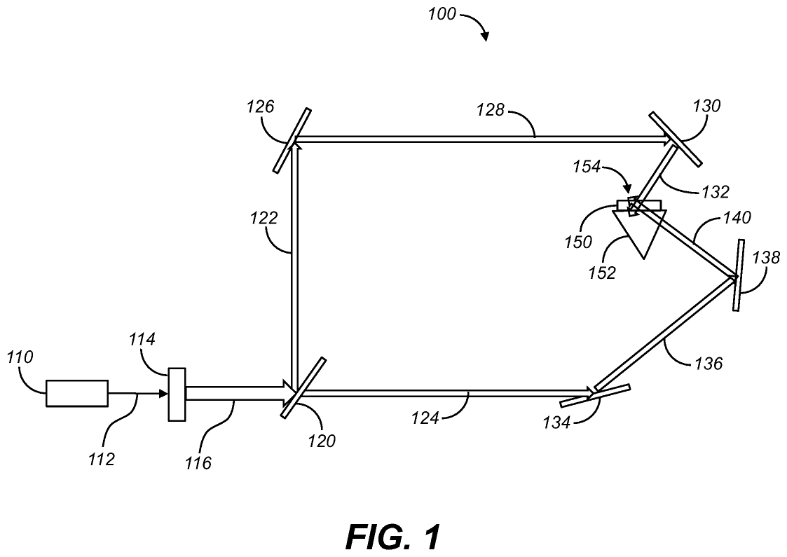

As illustrated in FIG. 1, in an embodiment, a holographic recording setup 100 is provided for creating the one or more holograms in a photopolymer recording media 150. The holographic recording setup 100, in an embodiment, is operable for recording one or more sets of Bragg planes within the photopolymer recording media 150. In this embodiment, a laser 110 generates a coherent light beam 112 that is expanded into an expanded beam 116 by a beam expander 114. A portion of the expanded beam 116 is reflected by a first half-mirror 120 (e.g., a beam splitter) to become beam 122 while another portion of expanded beam 116 continues beyond the first half-mirror 120 to become beam 124. In an embodiment, the first half-mirror 120 is a highly reflective mirror that intercepts only a portion of the expanded beam 116, allowing another portion of the expanded beam 116 to pass by. Alternatively, the first half-mirror 120 is a partially transmissive mirror. Beam 122 is reflected by a second mirror 126 to become beam 128. Beam 128 is reflected by a third mirror 130 to become beam 132. At least a portion of beam 132 intersects and passes through the photopolymer recording media 150.

Beam 124 is reflected by a fourth mirror 134 to become beam 136. Beam 136 reflects off of a fifth mirror 138 to become beam 140. At least a portion of beam 140 passes through a prism 152 and intersects and passes through the photopolymer recording media 150. The photopolymer recording media 150 in an embodiment is Bayfol® HX200, commercially available at www.solutions.covestro.com. However, other self-developing photopolymers that are operable to be recorded with laser light can be used. In at least one embodiment, the photopolymer recording media is operable to record with a laser light having a range from 440 nm to 680 nm. Interference at the intersection of the beam 132 and the beam 140 within a portion 154 of the photopolymer recording media 150 creates Bragg planes.

The holographic recording setup 100 is but one example of a recording setup for recording a hologram within photopolymer recording media 150. Object beam 132 and reference beam 140 are incident on the recording media 150, and form an interference pattern that is recorded within the recording medium. If the setup 100 is used within a very low humidity and chilled enclosure, it can be used to record holograms according to the present disclosure.

In the embodiment shown in FIG. 1, it is understood that object beam 132 is part of a single continuous beam from half-mirror 120, comprising the several beam portions 122, 128, 132, which is reflected by mirrors 126, 130. The several beam portions 122, 128, 132 are sometimes referred to herein as a first beam. Similarly, it is understood that reference beam 140 is part of a single continuous beam from mirror 120, comprising the several beam portions 124, 136, 140, which is reflected by mirrors 134, 138. The several beam portions 124, 136, 140 are sometimes referred to herein as a second beam. It should be appreciated that other holographic recording setups for creating one or more holograms in a photopolymer recording media 150 are possible, including but not limited to utilizing mirrors, beam splitters, prisms, and additional or fewer coherent light beams, and these modifications are intended to be included within the spirt and scope of the invention as described and claimed.

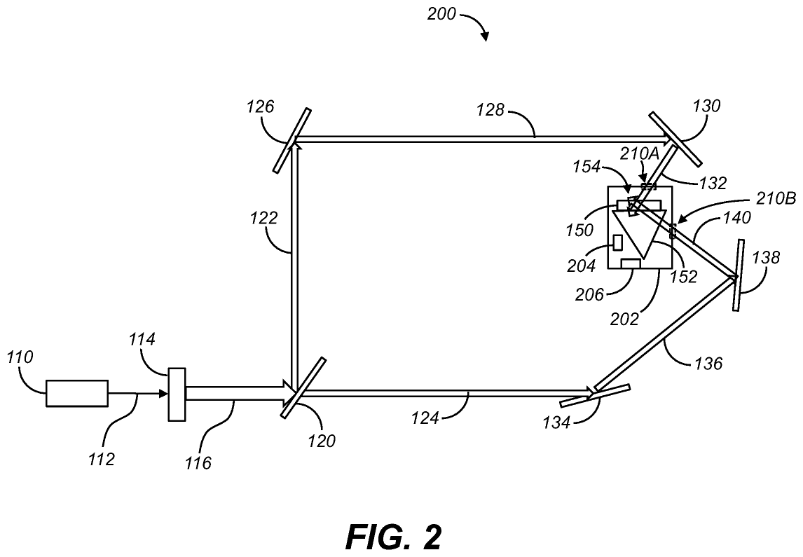

FIG. 2 shows a holographic recording setup 200 suitable for controlling the temperature of the photopolymer recording media 150 wherein like reference numbers refer to like elements of FIG. 1. The recording setup 200 includes an enclosure 202 enclosing the photopolymer recording media 150. In an embodiment, the enclosure 202 includes predefined optical holes 210A, 210B that allow beam 132 and beam 140, respectively, to optically pass through surfaces of the enclosure 202. In an embodiment, the predefined optical holes 210A, 210B are windows which allow beam 132 and beam 140 to optically pass through surfaces of the enclosure while maintaining the structural integrity of the surfaces of the enclosure 202. In some embodiments, optical holes 210A, 210B can have glass, quartz, or other optically transparent coverings, and in other embodiments, optical holes 210A, 210B can be pass-through holes. In an embodiment, the enclosure 202 is fabricated, in part, with a thermally insulative material. The enclosure 202, in an embodiment, is fabricated, at least in part, using aerogel insulative material.

In an embodiment, the enclosure 202 includes a heat exchanger 204 (e.g., heat pump) operable to reduce the air and/or the photopolymer recording media 150 temperature in a controlled manner. In an embodiment, the heat exchanger 204 is the cooling portion of a Peltier device. In another embodiment, the heat exchanger 204 is the cooling portion of a glycol-based recycling chilling system. In another embodiment, the heat exchanger 204 includes a water-based recycling chilling system. In another embodiment, the heat exchanger 204 includes thermally conductive tubing through which a chilled liquid or gas is passed. In an embodiment, the heat exchanger 204 is in contact with the photopolymer recording media 150 and/or prism 152. In one embodiment, the heat exchanger 204 reduces the environment temperature within enclosure 202 to approximately 2.5 C. In another embodiment, the heat exchanger 204 reduces the environment temperature within the enclosure 202 to a temperature range between approximately 1-degree C. and 5-degrees C. In another embodiment, the heat exchanger 204 reduces the environment temperature within enclosure the 202 to a temperature within the temperature range of approximately 0-degrees C. and 20-degrees C.

The enclosure 202 further comprise, in an embodiment, a humidity control system 206 suitable for reducing and controlling the relative humidity, of the enclosed air. A commercial humidity control system such as the Ecor Pro Dessicant Dehumidifier EPD30 3-Hole System can be used. In an embodiment, the enclosure 202 is operable to contain dry air. In another embodiment, the enclosure 202 is operable to contain dry nitrogen gas. In another embodiment, enclosure 202 is operable to contain Argon and/or other gasses. In another embodiment, enclosure 202 is a vacuum chamber. In another embodiment, the enclosure 202 is a chamber operable to hold a partial vacuum.

The presently disclosed method comprises, in one embodiment, the steps of:
1. loading the photopolymer recording media 150 into the enclosure 202,
2. activating the heat exchanger 204 and/or humidity control system 206,
3. monitoring the temperature of the photopolymer recording media 150,
4. cooling the photopolymer recording media 150 to a predetermined temperature (e.g., via waiting a predetermined amount of time or monitoring temperature of the photopolymer recording media 150 and/or the enclosure 202),
5. turning off the heat exchanger 204, and/or humidity control system 206,
6. waiting a predetermined amount of time for all vibrations associated with the heat exchanger 204 and/or humidity control system 206 to damp out, (optionally monitor/measure vibrations of the recording setup 200 to determine when vibrations are suitably small to allow recording),
7. exposing the photopolymer recording media 150 to holographic recording beams, object beam 132 and reference beam 140,
8. optionally repeating steps 2 through 7 for multiple holographic exposures,
9. heating the photopolymer recording media 150 to a predetermined temperature within the enclosure 202 or after removing the photopolymer recording media 150 from the enclosure 202.

When cooling the photopolymer recording media 150 to a predetermined temperature, according to step 4, the predetermined temperature of the photopolymer holographic recording medium, in an embodiment is approximately 2.5 C. In another embodiment, predetermined temperature of the photopolymer holographic recording medium is within the temperature range between approximately 1-degrees C. and 5-degrees C. In another embodiment, the predetermined temperature of the photopolymer holographic recording medium is within the temperature range below 20-degrees C. A predetermined amount of time to cool the photopolymer recording media 150 in one embodiment is within a range of 5 seconds to 10 minutes. In another embodiment, a predetermined amount of time to cool the photopolymer recording media 150 is within a range of 5 seconds and 5 minutes. In yet another embodiment, the predetermined amount of time to cool the photopolymer recording media 150 is within a range of 1 minute and 3 minutes.

According to step 6, in an embodiment, a predetermined amount of time is waited for all vibrations associated with the heat exchanger 204 and/or humidity control system 206 to damp out, (optionally monitor/measure vibrations of the recording setup 200 to determine when vibrations are suitably small to allow recording), The amount of time required for all vibrations associated with the heat exchanger 204 and/or humidity control system 206 to damp out can vary based on the selected heat exchanger and humidity control system. In an embodiment, the amount of time required is in the range of 1 second to 1 minute, and more preferably, between the range of 1 second to 30 seconds, and even more preferably is less than 15 seconds.

According to step 9, the photopolymer recording media 150 in an embodiment is heated to a predetermined temperature within the enclosure 202 or after removing the photopolymer recording media 150 from the enclosure 202. In an embodiment, the recorded photopolymer media is heated to room temperature, or approximately 20-degrees C. In another embodiment, the recorded photopolymer media is heated to a temperature in the range of between 5-degrees C. to 20-degrees C. In yet another embodiment, the recorded photopolymer media is heated to a temperature in the range between 10-degrees C. and 20-degrees C.

It is to be understood that, and as is known to those skilled in the art, utilization of the setup described in FIG. 1 and FIG. 2 are not the only possible setup for creating holograms. FIG. 1 and FIG. 2 are provided as one illustrative embodiment for the purposes of describing an embodiment.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A method for decreasing scatter or crosstalk in holographic elements recorded in self-developing media, comprising:
exposing a photopolymer recording media to a holographic pattern at a first temperature of said photopolymer recording media, wherein monomer diffusion is substantially reduced at said first temperature; and
warming said photopolymer recording media to a second temperature wherein monomer diffusion is enabled.

2. The method according to claim 1, wherein a rate of holographic development is increased at said second temperature relative to said first temperature.

3. The method according to claim 1, further comprising maintaining said photopolymer recording media at said first temperature during exposure to said holographic pattern, wherein said first temperature is below twenty-degrees Celsius.

4. The method according to claim 1, further comprising:
maintaining said photopolymer recording media at said first temperature during exposure to a first holographic pattern;
maintaining said photopolymer recording media at said first temperature during exposure to a second holographic pattern; and
maintaining said photopolymer recording media at said first temperature between exposure to said first and second holographic patterns.

5. The method according to claim 1, further comprising chilling a room in which said photopolymer recording media is exposed to said holographic pattern to a temperature at or below said first temperature.

6. The method according to claim 1, further comprising locating said photopolymer recording media in a temperature controlled enclosure, wherein said temperature controlled enclosure is operable to enable exposure of said photopolymer recording media to said holographic pattern.

7. The method according to claim 6, further comprising locating said photopolymer recording media in a humidity controlled enclosure, wherein said humidity controlled enclosure is operable to enable exposure of said photopolymer recording media to said holographic pattern.

8. The method according to claim 6, wherein said holographic pattern is a first holographic pattern, and said temperature controlled enclosure is operable to enable exposure of said photopolymer recording media to a second holographic pattern.

9. The method according to claim 7, wherein said holographic pattern is a first holographic pattern, and said humidity controlled enclosure is operable to enable exposure of said photopolymer recording media to a second holographic pattern.

10. The method according to claim 1, further comprising locating said photopolymer recording media on a substrate, and chilling said substrate to a temperature at or below said first temperature.

11. The method according to claim 1, wherein said first temperature is substantially at or below 2.5-degrees Celsius.

12. The method according to claim 1, further comprising exposing said photopolymer recording media to incoherent light at said second temperature.

13. The method according to claim 1, further comprising exposing said photopolymer recording media to two or more mutually incoherent light beams at said second temperature.

14. The method according to claim 6, wherein the step of exposing said photopolymer recording media to a holographic pattern includes:
generating a coherent light beam;
expanding said coherent light beam into an expanded beam with a beam expander;
splitting the expanded beam into a first beam and a second beam with a beam splitter; and
intersecting said first beam and said second beam within said photopolymer recording media to form said holographic element, wherein said temperature controlled enclosure includes said beam expander, said beam splitter, and said first and second beams.

15. The method according to claim 6, wherein the step of exposing said photopolymer recording media to a holographic pattern includes intersecting a first beam and a second beam within said photopolymer recording media to form said holographic element, wherein said temperature controlled enclosure includes enclosing surfaces having optical holes operable to optically pass said first beam and said second beam through said enclosing surfaces.

16. The method according to claim 7, wherein the step of exposing said photopolymer recording media to a holographic pattern includes:
generating a coherent light beam;
expanding said coherent light beam into an expanded beam with a beam expander;
splitting the expanded beam into a first beam and a second beam with a beam splitter; and
intersecting said first beam and said second beam within said photopolymer recording media to form said holographic element, wherein said humidity controlled enclosure includes said beam expander, said beam splitter, and said first and second beams.

17. The method according to claim 7, wherein the step of exposing said photopolymer recording media to a holographic pattern includes intersecting a first beam and a second beam within said photopolymer recording media to form said holographic element, wherein said humidity controlled enclosure includes enclosing surfaces having optical holes operable to optically pass said first beam and said second beam through the enclosing surfaces.

18. A holographic recording apparatus for decreasing scatter or crosstalk in holographic elements recorded in self-developing media, comprising:
a light source operable to generate a coherent light beam;
a beam expander operable to expand said coherent light beam into an expanded beam;
a beam splitter operable to form a first beam and a second beam from said expanded beam, said first beam and second beam intersecting said photopolymer recording media, wherein interference of said first and second beams within said photopolymer recording media is operable to form Bragg planes; and
a temperature controlled enclosure located about said photopolymer recording media, wherein said first and second beams are operable to intersect within said enclosure.

19. The holographic recording apparatus according to claim 18, wherein said enclosure at least partially comprises a thermally insulative material.

20. The holographic recording apparatus according to claim 18, wherein said enclosure includes a heat pump operable to reduce a temperature within said enclosure.

21. The holographic recording apparatus according to claim 18, wherein said enclosure comprises one or more temperature sensors operable to determine a temperature of said photopolymer recording media.

22. The holographic recording apparatus according to claim 18, wherein said enclosure comprises a humidity control system operable to control humidity within said enclosure.

23. The holographic recording apparatus according to claim 18, wherein said enclosure comprises one or more humidity sensors operable to determine a humidity within said enclosure.
